(19) United States
(12) Patent Application Publication
(10) Pub. No.: US 2026/0094988 A1
(43) Pub. Date: Apr. 2, 2026

(54) FLOATING CONNECTOR

(71) Applicants: NIDEC MOBILITY CORPORATION, Aichi (JP); GREENCONN TECHNOLOGY (GANZHOU) LTD., Jiangxi (CN)

(72) Inventors: Katsuya KOYAMA, Aisai (JP); Yoshiaki MATSUO, Utsunomiya (JP); Masami NOGUCHI, Nagakute (JP); Kazuhiro MAKIUCHI, Komaki (JP); Shuji IWASAKI, Kasugai (JP); YEN CHAO CHEN, Ganzhou (CN)

(73) Assignees: NIDEC MOBILITY CORPORATION, Aichi (JP); GREENCONN TECHNOLOGY (GANZHOU) LTD., Jiangxi (CN)

(21) Appl. No.: 19/300,656

(22) Filed: Aug. 14, 2025

(30) Foreign Application Priority Data
Sep. 30, 2024 (JP) 2024-170739

(51) Int. Cl. H01R 12/91; H01R 12/70; H01R 13/11

(52) U.S. Cl. CPC H01R 12/91; H01R 12/707; H01R 13/114; H01R 2201/26

(57) ABSTRACT

A floating connector includes: an outer socket; an inner socket, of which a movement relative to the outer socket is allowed; and at least one terminal, into which at least one pin, which is a connection target, is inserted. The terminal includes: a tip connection part; a spring part; an outer socket fixing part; and a circuit connection part. The tip connection part includes: a base part continuous in a circumferential direction; and four holding parts that are branched into four from the base part toward a Z-direction defining a height direction of the inner socket. The four holding parts include two X-direction holding parts that hold the pin in an X-direction defining a length direction of the inner socket, and two Y-direction holding parts that hold the pin in a Y-direction defining a width direction of the inner socket. Accordingly, the issues are solved.

### CROSS REFERENCE TO RELATED APPLICATIONS

The present invention claims priority under 35 U.S.C. § 119 to Japanese Application No. 2024-170739 filed on Sep. 30, 2024, the entire content of which is incorporated herein by reference.

### TECHNICAL FIELD

The invention relates to a floating connector that can move in a wide range in multiple directions.

### BACKGROUND

Conventionally, as shown in Patent Document 1, for example, a floating connector that reduces repeated sliding, etc., between a contact part and a connection target in a connector having a movable housing is known.

The conventional floating connector has a configuration in which a pin, which is a plug, is inserted into a socket, and multiple contact parts formed on the terminal of the socket sandwich the pin from both sides, thereby rendering an electrical connection. In addition, the terminal has a plate spring that allows elastic deformation, which enables a contact part of the terminal to be displaced to a certain degree in the case where there is a misalignment between the pin and the terminal, thereby absorbing the misalignment. In the configuration, it is necessary to increase the contact force between the pin and the contact part of the terminal to reduce sliding wear between the pin and the contact part of the terminal. However, to increase the contact force between the pin and the contact part of the terminal, the distance to the contact part of the terminal must be set to be narrow, and a high stress is applied to the contact part of the terminal when the pin is press-fitted with the terminal, and if the displacement amount of the contact part of the terminal is not reduced, an even greater stress may be applied to the contact part of the terminal. As a result, in a vibration test, a damage to the terminal is predicted. To avoid this, if the displacement amount of the contact part of the terminal is increased, the press-fitting force of the pin into the terminal needs to be reduced, making sliding wear between the pin and the contact part of the terminal more likely to occur. Thus, in the conventional connection mode, since there is a trade-off relationship between the contact force between the pin and the contact part of the terminal and the displacement amount of the contact part of the terminal, the issue of the sliding wear between the pin and the terminal cannot be efficiently addressed.

### SUMMARY

A floating connector includes: an outer socket; an inner socket, of which a movement relative to the outer socket is allowed; and at least one terminal, into which at least one pin, which is a connection target, is inserted. The terminal includes: a tip connection part; a spring part; an outer socket fixing part; and a circuit connection part. The tip connection part includes: a base part continuous in a circumferential direction; and four holding parts that are branched into four from the base part toward a Z-direction defining a height direction of the inner socket. The four holding parts include two X-direction holding parts that hold the pin in an X-direction defining a length direction of the inner socket, and two Y-direction holding parts that hold the pin in a Y-direction defining a width direction of the inner socket.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing a connection state resulting from a connector set.

FIGS. 2A to 2D are views showing a floating connector according to an embodiment of the invention, where FIG. 2A is a front view, FIG. 2B is a top view, FIG. 2C is a bottom view, and

FIG. 2D is a side view.

FIGS. 3A and 3B are views showing the floating connector according to an embodiment of the invention, where FIG. 3A is a front cross-sectional view, and FIG. 3B is a side cross-sectional view.

FIG. 4 is a perspective view showing a terminal according to an embodiment of the invention.

FIG. 5 is a development view of a terminal according to an embodiment of the invention.

FIGS. 6A and 6B are perspective views showing a state where a pin is inserted into a terminal according to an embodiment of the invention, where FIG. 6A is a view showing the state where the pin is inserted into the terminal in FIG. 4, and FIG. 6B is a view showing that the state of FIG. 6A is rotated 90 degrees counterclockwise in the axial direction of the pin.

FIGS. 7A to 7D are views showing a floating connector according to another embodiment of the invention, where FIG. 7A is a front view, FIG. 7B is a top view, FIG. 7C is a bottom view, and FIG. 7D is a side view.

FIG. 8 is a view of a floating connector according to another embodiment of the invention when viewed from the bottom.

### DESCRIPTION OF THE EMBODIMENTS

Hereinafter, examples of embodiments of a floating connector according to the invention will be described based on the drawings, but the following drawings are created for the purpose of description, and, for the case of understanding, components not requiring description may be intentionally omitted. Also, for the purpose of description, components may be intentionally shown larger or smaller, and the drawings do not show accurate scale. In the following description, the same reference numerals in different figures indicate parts with the same function, and repeated descriptions for each figure are appropriately omitted.

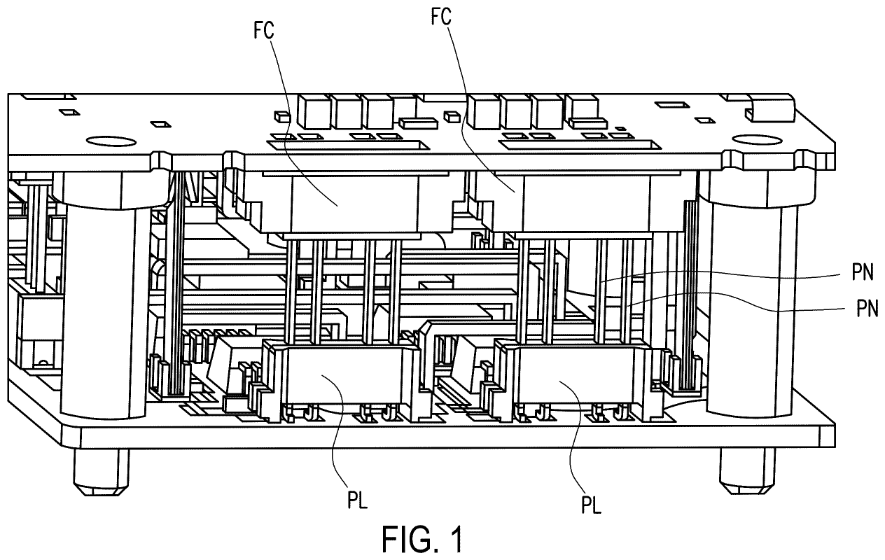

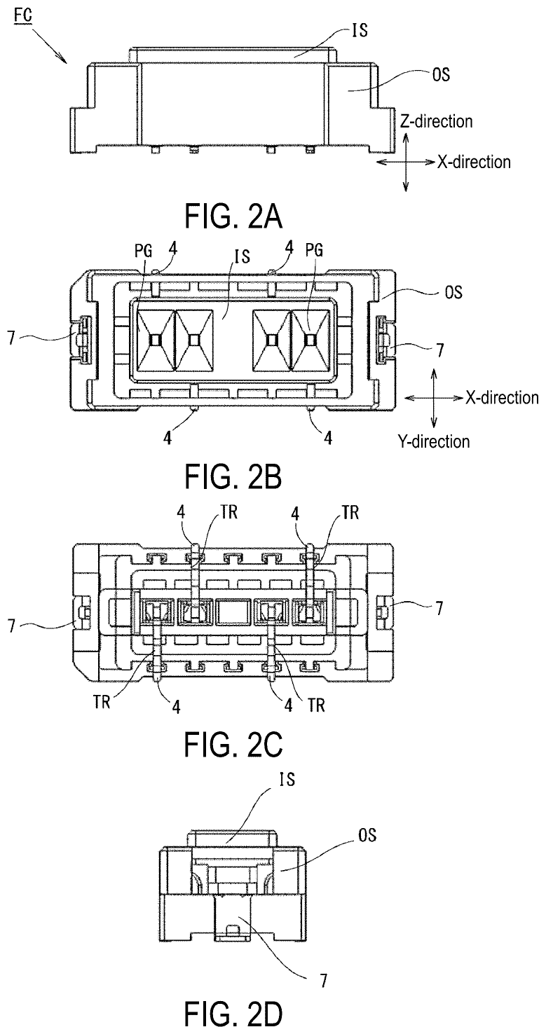

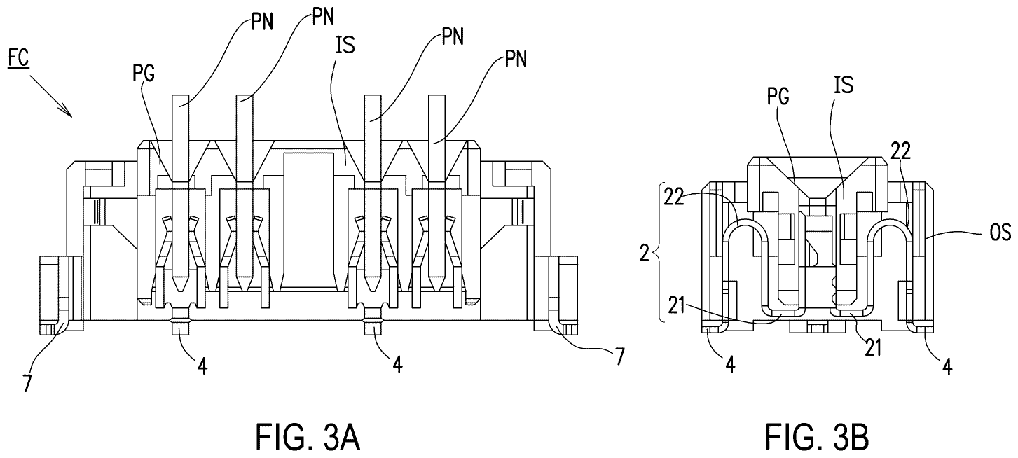

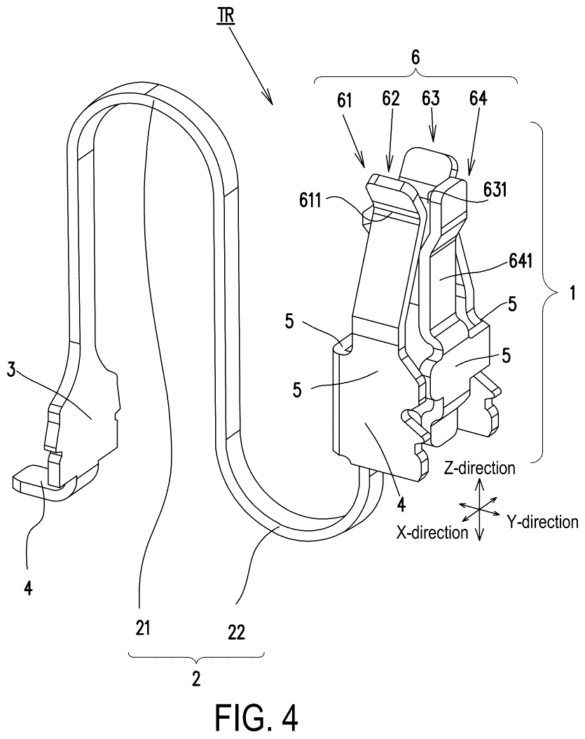

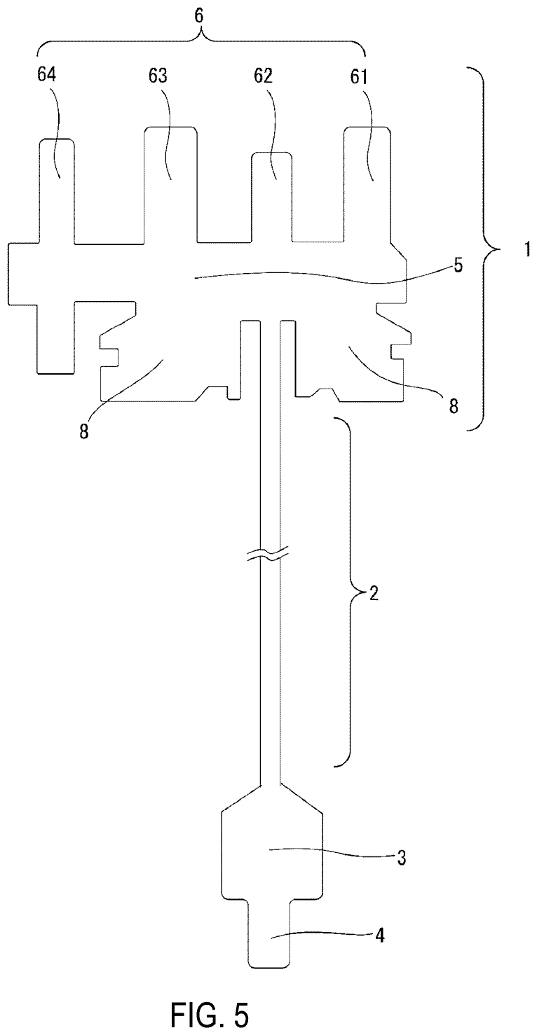

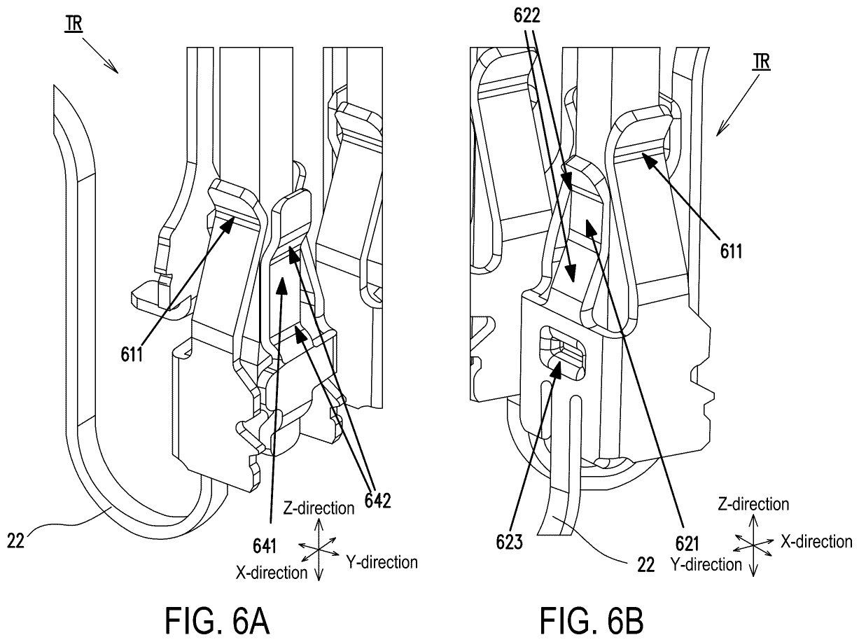

FIG. 1 is a perspective view showing a connection condition resulting from a connector set to describe the premise of a floating connector according to an embodiment of the invention. Specifically, FIG. 1 shows a state where a floating connector FC and a plug PL are connected via a pin PN. The floating connector FC has an inner socket IS that displaces relative to a circuit board as an attachment target. The plug PL is attached to another circuit board. FIG. 2 and FIG. 3 show the floating connector FC according to an embodiment of the invention, and FIG. 4, FIG. 5, and FIG. 6 show a terminal TR which is a component of the floating connector FC according to an embodiment of the invention.

The connector set serves to establish an electrical connection with the pin PN extending from the plug PL while allowing physical displacement, and is generally formed by the floating connector FC, the plug PL, and the pin PN as shown in FIG. 1. The connector set is used, for example, to connect different circuit boards provided in an automobile part and is used in a vibration environment such as in an automobile.

The floating connector FC, as shown in FIGS. 2A to 2D, includes an outer socket OS fixed to an attachment target, such as a circuit board, and an inner socket IS that can be displaced relative to the circuit board. The outer socket OS and the inner socket IS are fixed to each other via the terminal TR. The terminal TR has a tip connection part 1, a spring part 2, an outer socket fixing part 3, a circuit connection part 4, and an inner socket fixing part 8, and the outer socket fixing part 3 and the inner socket fixing part 8 are fixed respectively to the outer socket OS and the inner socket IS. Here, the floating connector FC shown in FIGS. 2A to 2D is shown in an upside-down state with respect to the floating connector FC shown in FIG. 1. Hereinafter, as shown in FIGS. 2A to 2D, the direction defining the length direction of the inner socket IS is referred to as the X-direction, the direction defining the width direction of the inner socket IS is referred to as the Y-direction, and the direction defining the height direction of the inner socket IS is referred to as the Z-direction for the description.

As shown in FIG. 3A, the outer socket OS is fixed by soldering multiple circuit connection parts 4 and multiple substrate connection parts 7 to connection positions of the circuit board. Meanwhile, the inner socket IS, as shown in FIG. 3B and FIG. 4, is held relative to the outer socket OS, with the terminal TR being fixed to the outer socket and the inner socket respectively by using the outer socket fixing part 3 and the inner socket fixing part 8. With the flexing of the spring part 2 of the terminal TR, the inner socket IS is able to displace in the directions of three axes, i.e., X-direction, Y-direction, and Z-direction. In the inner socket IS, a funnel-shaped pin guide PG that guides the pin PN is provided, as shown in FIG. 3A.

The plug PL is attached to a circuit board different from the circuit board to which the floating connector FC is attached. For example, in the case of being used in the connection for the circuit board of the automobile part, the pin PN provided in the plug PL and the connection part of the terminal TR of the floating connector FC are arranged in a vibration environment caused by the automobile. However, the terminal TR to which the pin PN is connected has the spring part 2, and the vibration transmitted from the pin PN can be absorbed. Specifically, the four terminals TR are shown in FIG. 2C as extending alternately up and down, and the extending portion is configured to include bending parts 21, 22 at two locations as shown in FIG. 3B, and together with a straight part connecting the bending parts, the entirety serves as the spring part 2.

The terminal TR, as shown in the perspective view of FIG. 4 and the development view of FIG. 5, includes the spring part 2, a base part 5 that is continuous in the circumferential direction, four holding parts 6 that branch into four from the base part 5 toward the Z-direction defining the height direction of the inner socket IS, a circuit connection part 4, an outer socket fixing part 3, and an inner socket fixing part 8. The base part 5, the four holding parts 6, and the inner socket fixing part 8 form the tip connection part 1. The spring part 2 makes the inner socket IS displaceable relative to the outer socket OS by connecting the base part 5 and the outer socket fixing part 3. The circuit connection part 4 is fixed to the circuit board by soldering, and the outer socket fixing part 3 continuous with the circuit connection part 4 is fixed to the outer socket OS. The circuit connection part 4 serves for electrical connection with the circuit board and also serves to fix the outer socket OS to the circuit board. The four holding parts 6 are formed by two X-direction holding parts 61, 63 that hold the pin PN in the X-direction defining the length direction of the inner socket IS, and two Y-direction holding parts 62, 64 that hold the pin PN in the Y-direction defining the width direction of the inner socket IS. The terminal TR, as shown in the development view of FIG. 5, is finished into the shape shown in FIG. 4 through pressing and bending in combination after a punching process using a die.

While a conventional floating connector has a configuration that renders the connection by sandwiching the pin with the terminal in one direction or one axis, the floating connector FC of the embodiment has a configuration that sandwiches the pin with the terminal in two axes, the X-direction and Y-direction. Accordingly, the contact pressure per axis can be reduced, while the overall holding force of the two axes can be held to the same degree as the conventional floating connector. As a result, the displacement amount of the contact part of the terminal TR can be increased.

In the terminal of the embodiment, the two X-direction holding parts 61, 63 and the two Y-direction holding parts 62, 64 that hold the pin PN provide, as a whole, four contact parts that contact the pin PN. Specifically, the two X-direction holding parts 61, 63 have two X-direction contact parts 611, 631 that contact the pin PN, and the two Y-direction holding parts 62, 64 have two Y-direction contact parts 621, 641 that contact the pin PN. The two X-direction contact parts 611, 631 and two Y-direction contact parts 621, 641 are disposed at different positions with respect to the Z-direction, as shown in FIG. 4. Accordingly, the contact pressure is prevented from being applied from two axes to the pin PN at the same height position, and the contact pressure to the pin PN is distributed in the height direction. Therefore, fatigue failure of components due to repeated sliding between the contact part and the connection target is prevented.

FIG. 4 shows the terminal TR at a stage before the pin PN is inserted, where the two X-direction holding parts 61, 63 are positioned between the two Y-direction holding parts 62, 64. In other words, in the state before the pin PN is inserted, the distance between the two X-direction contact parts 611, 631 is set shorter than the distance between the two Y-direction contact parts 621, 641.

In addition, as shown in FIGS. 6A and 6B, the holding of the pin PN in the X-direction is achieved by the X-direction contact parts 611, 631 pressing the pin PN through linear contact of the pressing bending parts, whereas the holding of the pin PN in the Y-direction is achieved by the straight parts formed continuously with the pressing bending parts 622, 642 serving as the Y-direction contact parts 621, 641 to press the pin PN.

In other words, by having the Y-direction contact parts contact the pin PN in a planar manner, fatigue failure of components due to repeated sliding between the contact part and the connection target can be more effectively prevented.

The Y-direction holding part 62, which is one of the two Y-direction holding parts, has a protrusion part 623 on the base part 5. The protrusion part 623 regulates the pin PN so that the pin PIN does not tilt at the time when the force is applied in a direction in which the pin PN tilts. The Y-direction holding part 64, which is the other one of the two Y-direction holding parts, does not have a protrusion part. The two Y-direction holding parts 62, 64 are configured to be continuous via the base part 5, as shown in FIG. 5.

The spring part 2, as shown in FIG. 4, has folding parts 21, 22 at two positions. Also, the folding parts 21, 22 are formed to be R-shaped. The conventional floating connector is designed to allow displacement only in one direction in a horizontal plane and the Z-direction, which are known from experience to have a large vibration, but with the two R-shaped folding parts 21, 22 having large curvature, the floating connector is configured to allow displacement not only in the Y-direction, which is the bending direction, but also in the X-direction perpendicular to the Y-direction. When the automobile travels, depending on the road surface condition, vibrations may occur in multiple directions, so it is advantageous to be able to allow displacement in the directions of three axes.

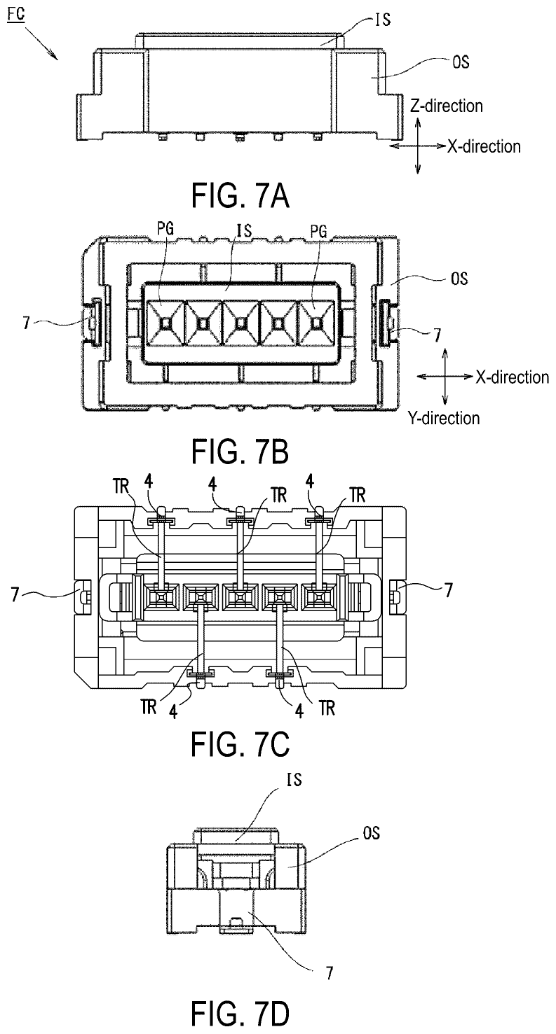

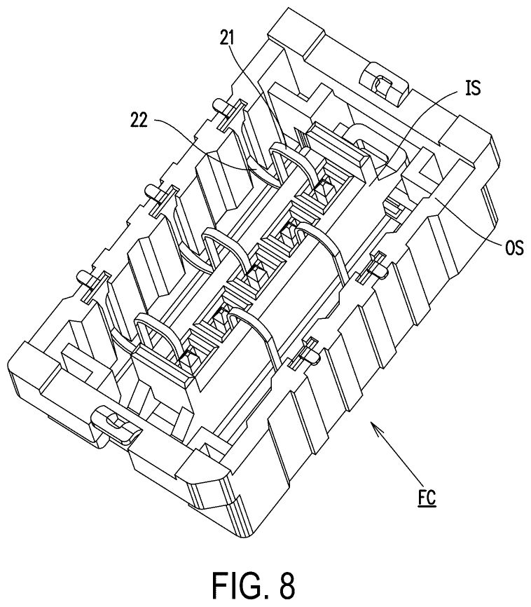

FIGS. 7A to 7D and FIG. 8 are views showing another embodiment of the invention. FIGS. 7A to 7D are views showing a floating connector according to another embodiment of the invention, where FIG. 7A is a front view, FIG. 7B is a top view, FIG. 7C is a bottom view, and FIG. 7D is a side view. FIG. 8 is a view illustrating a floating connector according to another embodiment of the invention when viewed from the bottom.

While the previously shown embodiment is a connector through 4-pin connection, another embodiment is a connector through 5-pin connection. As shown in FIG. 7C and FIG. 8, the spring part 2 of the terminal TR extends in one direction of the Y-direction in two places and extends in the other direction of the Y-direction in three places. According to FIG. 8, it can be seen that the two R-shaped folding parts 21, 22 are widely arranged across the upper and lower portions in the Z-direction. As illustrated, the two R shapes have a large curvature, making it possible to follow not only the movement of the pin PN in the Y-direction but also the movement in the X-direction.

The floating connector according to the embodiment and another embodiment of the invention has been described in detail above, but the specific configuration is not limited to these embodiments, and the invention includes design changes, etc., that do not depart from the scope of the invention.

For example, the connector may have a number of pins of 3 or fewer, or 6 or more, in addition to 4 pins or 5 pins.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A floating connector, comprising: an outer socket; an inner socket, of which a movement relative to the outer socket is allowed; and at least one terminal, into which at least one pin, which is a connection target, is inserted,
wherein the terminal comprises: a tip connection part; a spring part; an outer socket fixing part; and a circuit connection part,
the tip connection part comprises: a base part continuous in a circumferential direction; and four holding parts that are branched into four from the base part toward a Z-direction defining a height direction of the inner socket, and
the four holding parts comprise two X-direction holding parts that hold the pin in an X-direction defining a length direction of the inner socket, and two Y-direction holding parts that hold the pin in a Y-direction defining a width direction of the inner socket.

2. The floating connector as claimed in claim 1, wherein the X-direction holding part has an X-direction contact part that contacts the pin, the Y-direction holding part has a Y-direction contact part that contacts the pin, and the X-direction contact part and the Y-direction contact part are disposed at positions different from each other with respect to the Z-direction.

3. The floating connector as claimed in claim 2, wherein in a state before the pin is inserted, a distance between the two X-direction contact parts is smaller than a distance between the two Y-direction contact parts.

4. The floating connector as claimed in claim 2, wherein the Y-direction holding part is formed by a pressing bending part and a straight part, and
the straight part is the Y-direction contact part.

5. The floating connector as claimed in claim 4, wherein the base part continuous with one of the two Y-direction holding parts has a protrusion part that restricts the pin from tilting.

6. The floating connector as claimed in claim 5, wherein the one of the Y-direction holding parts is formed with the spring part via the base part.

7. The floating connector as claimed in claim 4, wherein the one and the other one of the Y-direction holding parts are connected by the base part.

8. The floating connector as claimed in claim 1, wherein the spring part has folding parts at two positions, and
the bending parts are arranged to be R-shaped.
